(19) United States
(12) Patent Application Publication
(10) Pub. No.: US 2002/0147789 A1
(43) Pub. Date: Oct. 10, 2002

(54) Virtual filing system

(76) Inventors: Robert N. Higbee, Plano, TX (US); John J. Kendrick JR., Dallas, TX (US); Timothy F. Loomis, Plano, TX (US)

Correspondence Address: LAW OFFICES OF, TIMOTHY F. LOOMIS, 2932 HAGEM DRIVE, PLANO, TX, 75025, US

(21) Appl. No.: 09/826,725

(22) Filed: Apr. 5, 2001

(51) Int. Cl. G06F 15/16

(52) U.S. Cl. 709/217

(57) ABSTRACT

A system and method for providing a remote office where documents are stored in a separate location on a storage medium. The documents are available to the remote office through a secure link over the Internet.

### FIELD OF THE INVENTION

This invention relates to a system and method for providing a virtual filing system where documents are stored in a location physically separate from an office on a storage medium. The documents are available to the office through a secure link over the Internet.

### BACKGROUND OF THE INVENTION

In the past, telecommuters operating from a home office have had access to the internal networks within companies through dial-in access or through the Internet. Access to that network provided the telecommuters with access to documents existing on the internal network, such as email or word processing documents.

However, electronic documents that exist in programs not supported by the computer a telecommuter is using are unavailable to them. Additionally, paper documents are not available. In order to gain access to paper documents at the company, a telecommuter would have to have someone at the company fax or otherwise send the paper document to him. If the telecommuter doesn't know the precise location of that document, it can be a problem having the person at the company find it.

Many people travel on business. While traveling, they may set up a remote office in a hotel room or at another site. Such people may also find a need for documents that they did not bring with them.

Thus, a need exists for a virtual filing system and method that will provide a user with the ability to access documents from a remote location in an easy and secure fashion.

### SUMMARY OF THE INVENTION

An embodiment of the present invention provides a secure method of accessing documents from a remote location.

Another embodiment of the present invention provides a virtual filing repository for a physically remote office in which documents are stored on a database that is securely accessible over the Internet.

As such, it is an object of the present invention to provide for the secure access to documents from a remote location.

It is a further object of the present invention to provide a virtual filing repository for storing documents accessible from a physically remote location over the Internet.

### BRIEF DESCRIPTION OF THE DRAWINGS

FIG. 1 is a block diagram of a virtual filing repository according to an embodiment of the present invention.

FIG. 2 is a flow chart showing the process of the first portion of a virtual filing service according to an embodiment of the present invention.

FIG. 3 is a flow chart showing the process of the second portion of a virtual filing service according to an embodiment of the present invention.

### DESCRIPTION OF THE PREFERRED EMBODIMENTS

The present invention will be better understood by reference to the accompanying drawings.

A system such as that disclosed in patent application Ser. No. 09/783,161 filed on Feb. 14, 2001, and assigned to ControlDocs Operating Corp., may be modified to provide a service as disclosed herein. That application is herein incorporated by reference.

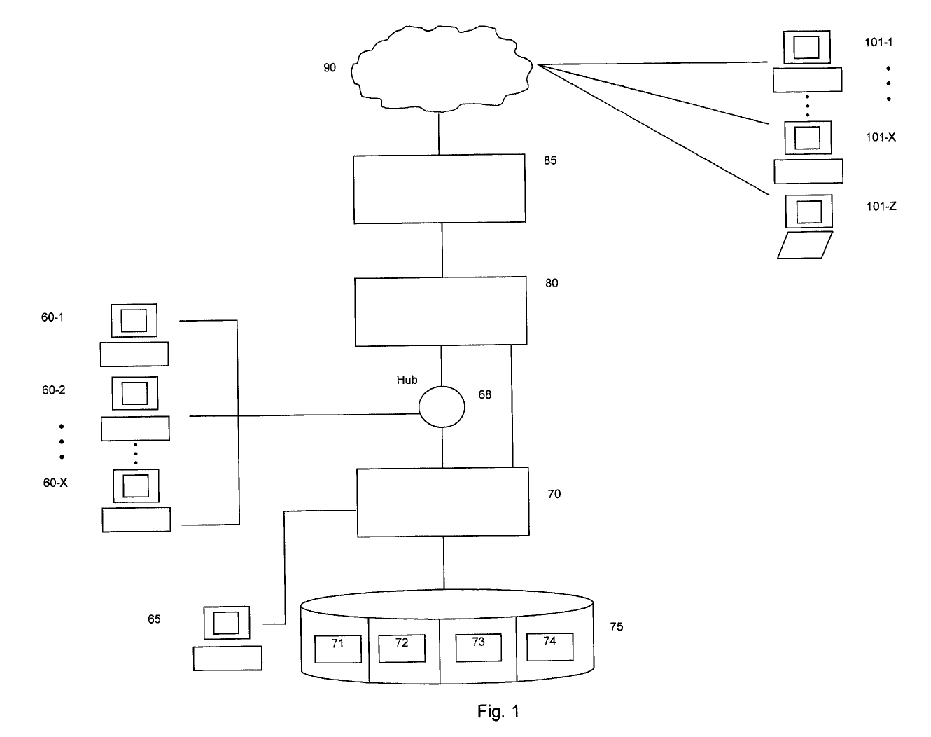

An embodiment of the present invention is depicted in FIG. 1. Referring to that figure, a database 75 for storing images of paper documents and electronic documents, document indexes and/or summaries (for simplicity purposes, the term index as used hereinafter shall mean index and/or summary), OCR records of documents and notes is provided. Preferably, the database is a RAID array. Alternatively, multiple separate databases or other electronic storage media could be used.

Document management service 70 is connected to database 75. Document management service 70 provides the interface between the database and the outside world. It provides the search, retrieval and note taking capabilities to the remote office user. Document management service 70 includes capabilities such as those provided by software commercially available from Precise Systems Corporation, including document collection, database creation and indexing of documents. It may also contain a format conversion tool for converting incoming electronic documents to a standard format for storage and delivery.

Managers can be connected to the document management service 70, such as manager 65. Manager 65 can provide management functions, such as password assignment for remote offices, account management, other security functions and database administration.

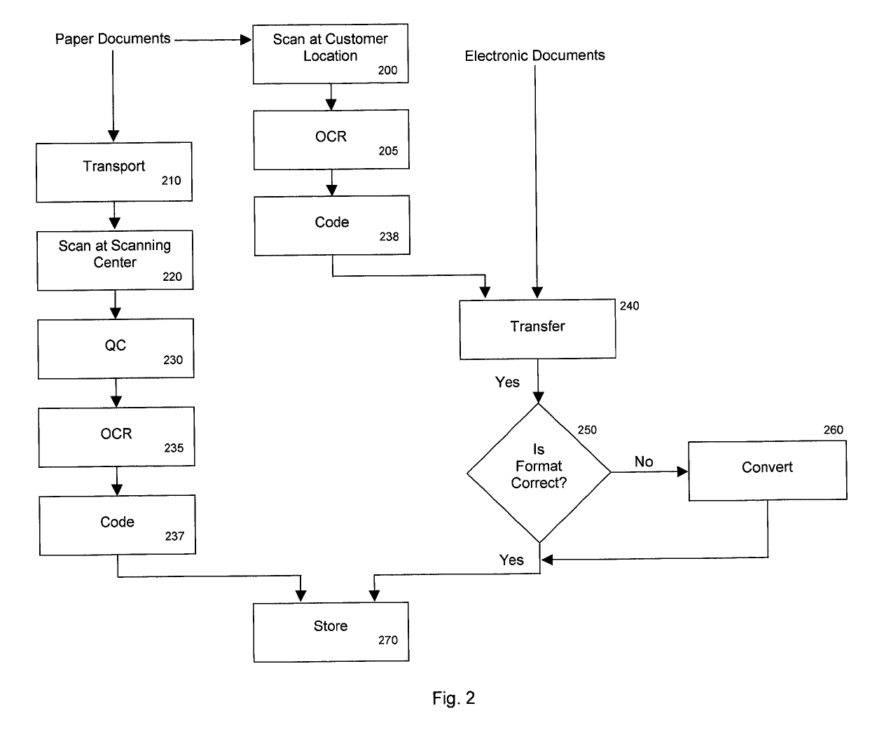

Document management service 70 may also be connected to a hub 68 for providing access to the service for document workers 60-1 through 60-x. This permits document workers 60-1 through 60-x to scan, store and code paper documents in database 75. This process will be discussed more thoroughly with regards to FIG. 2.

Hub 68 and document management service 70 can be connected to a web server and firewall 80 for providing secure access to the Internet 90. As used herein, the Internet shall encompass not only the present day Internet, but any future network that provides the broad connectivity that the Internet currently does. A router 85 may be included for connection to Internet 90. By connecting hub 68 to the Internet 90, access is provided for document workers 60-1 through 60-x to the Internet 90 so that they may communicate with remote office users if problems occur when inputting documents into the repository. Alternatively, if this arrangement causes security concerns, hub 68 could not be attached to webserver and firewall 80. Under this alternative arrangement, document workers 60-1 through 60-x would be forced to go through document control service 70 to access the Internet. The notification of a document ready to be delivered could alternatively be automated by document control service 70.

Telecommuters 101-1 through 101-x have access to their office documents that are stored in database 75 through the Internet 90. Telecommuters 101-1 through 101-x may also access a document through a search of OCR files representing documents, such as OCR file 73. Document management service 70 would provide the search functions.

Preferably, document control system 70 would provide the telecommuters with the ability to provide notes relating to the document, such as notes 74. Note making capability is currently available in litigation management software from Precise Systems, Inc. By providing note capability, the telecommuter would be able to save comments and thoughts regarding the document without altering the document. Preferably, notes 74 would be associated with image 71 so that a user could selectively change between viewing image 71 and notes 74. Also, preferably, notes 74 would be associated with image 71 in such a way that they would appear to the user to be the image 71 with certain text highlighted and/or with sticky pad notes attached. The highlighting could be, for instance, a contrasting color overlaid on the document, different colored text, boxed or circled text, bolded text, underlined text, italicized text, or the like.

Traveler 101-z, a person traveling and operating a laptop from a location remote from his office and from the document storage area, is also connected through the Internet 90 to the document management service 70 and database 75. Preferably, traveler 101-z interoperates with the central document storage area just as telecommuters 101-1 through 101-x, so that when a telecommuter that normally accesses the documents through a fixed location has to travel and needs to access documents, the procedure he has to undertake is the same.

In FIG. 2, a flow chart showing the process of setting up a virtual filing system according to an embodiment of the present invention is provided. Two separate process flows are depicted—one for paper documents and the other for electronic documents. A paper document needs to be scanned prior to it being stored in the virtual filing system. If the person placing documents within the virtual filing cabinet has a scanner available to him, he could scan the document locally as shown in step 200 and send the image of the document electronically by, for example, attaching it to an email to the virtual filing system as shown in step 240. An optical character recognition process could be applied to the image to produce a searchable representation of the image as shown in step 205 and coding can be performed to create an index in step 238. These last two processes could be performed either prior to or after transfer to the virtual filing system.

If the person placing documents within the virtual filing cabinet prefers, he could transport the documents to a scanning center as shown in step 210. In step 220, an incoming paper document is scanned at the scanning center into the system to create an image of the document. Preferably, scanning stations will be set up in cities near major customer locations so that each customer can get the documents to be installed in their virtual filing cabinets to a scanning station in a short period of time. In step 230, a quality control procedure can be undertaken to ensure that the document has been properly scanned. An optical character recognition process could be applied to the image to produce a searchable representation of the image as shown in step 235. Once this is complete, coding of the document can be performed to create an index in step 237. The document is then stored in the virtual filing cabinet in step 270.

If the documents are originally in electronic form, the person setting up the virtual filing system simply transfers the electronic documents to the virtual filing system. If the virtual filing system is remotely located and/or independent from the sender, the sender may simply attach the electronic documents to email and send them to the filing system via the Internet to a designated email address.

Once an electronic document is received by the virtual filing system, it is determined in step 250 if the document is in the appropriate format for storage. If it is not, it is converted to the appropriate format in step 260. In step 265, a quality control process can be undertaken.

Once the document exists in the appropriate format, it is stored into database 75 in step 270. This places the document in the users virtual filing cabinet and makes the document available to the remote office user.

Preferably, a user would be permitted to set up file folders within the virtual filing cabinet to hold specific documents or other folders. This could be performed by document workers 60-1 through 60-x at the remote filing system based upon instructions given by the user during the transmission of the documents to the system or to a scanning center. The document management system 70 can provide the ability to set up such folders.

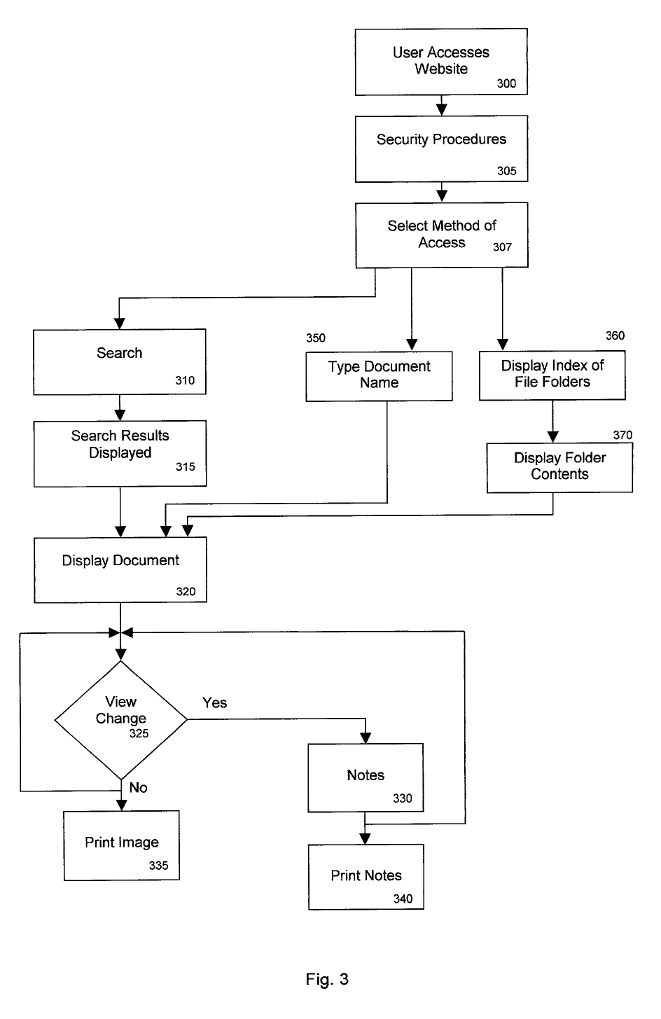

FIG. 3 shows the process undertaken to access a document within the virtual filing system from a remote office location according to an embodiment of the present invention. In step 300, a user accesses the website of the virtual filing system through the Internet. By having the website accessible via the Internet, users working on fixed sites, such as telecommuters 101-1 through 101-x can have access to the documents stored therein, as well as users who are traveling, such as traveler 101-z.

After the user accesses the website, in step 305 security procedures are engaged in order to permit the user to access the documents within his virtual filing cabinet from database 75. Preferably, the security procedures include requiring the user to log on to the secure portion of the website, prior to gaining access to his virtual filing cabinet 70. Preferably, the user will be required to enter a unique user ID and password and further transmission of information between the user and the central document storage system will be encrypted. Thus, any information intercepted by a third party will be unintelligible. This is important because many documents existing in the virtual filing system may cause strong security concerns among the users of such a system. The user ID and password could be stored in the user's computer, so that the user does not need to reenter it every time he logs in or he could be required to enter them each time, depending on the security concerns involved. The user ID and password should sufficiently identify the user so that access can be granted only to documents within database 75 that are within that person's virtual filing cabinet. ID, password and encryption software are currently widely available and such software could be integrated into web server and firewall 80 and/or document management service 70 to address the security concerns.

Once access to the secure portion of the website is accomplished, the user should be able to access documents within his virtual filing cabinet through various methods as shown in step 307. One method should be through direct access by typing in the filename of a document as shown in step 350. Once the filename is input, an image of the document is displayed in step 320.

Another method is through an index of file folders. The user should also be able to access a list of file folders within the virtual filing cabinet as shown in step 360. The list is preferably hyperlinks to the file folders. When a user clicks on a file folder, a list of subfolders and/or documents should be presented as shown in step 370. Once the user clicks on a particular document name, the image of that particular document is then displayed as shown in step 320.

Another method is through a search. In this method a search page is displayed in step 310, enabling the user to search the OCR files within his virtual filing cabinet or a select group of documents (such as a virtual file folder) for specific information. For example, user 101-1 could enter a search term of “Robert Smith” from the search group of “letters” to search for letters that mention Mr. Smith. Many search engines are currently commercially available that can be integrated into document management service 70 to handle the search functions.

In step 315, the results of the search are displayed, preferably as a list of hyperlinks to the images associated with the OCR files. In the example listed above, for instance, five letters written by Mr. Smith, three letters to Mr. Smith and 2 letters that mention Mr. Smith could be listed. If the user were to click on one of the an item in the list, he should then be shown the image of the corresponding document stored on database 75, as noted in step 320. Preferably, any attachments to the document would be available to the user through hyperlinks displayed along with the image of the document.

If only one document is available, it could be listed, or alternatively, the image of the document could be presented to the user without the necessity for the user to select the document. In step 315, the user selects the document he wishes to be delivered by clicking on one of the items in the list. He is then shown the image of the document stored on database 75, as noted in step 320.

When shown the image of the document, the user should be able to magnify the document and rotate the document to improve legibility. Software permitting such manipulation of documents is currently commercially available. Also, the user should be able to change the view as shown in step 325 to display any notes relating to the document being viewed. Preferably, the notes view as mentioned in step 330 would look like the image but with notes superimposed upon the image, so that highlighting could be added. The notes, for instance, could appear similar to sticky notes. The user should be able to add to the notes and/or amend the notes as well.

The user is also permitted to print the document in step 335 or the notes in step 340. Preferably, this would print the entire selected document (not just the page being viewed) locally at the user's current location. Thus, if a user were away from his home office he could easily print copies of the document he is accessing. Alternatively, the document could be downloaded by the user. If desired, the logic flow can be arranged differently than is shown in FIG. 3. For example, a user could be able to print the document while viewing the notes or print the notes while viewing the document.

Although the preferred embodiments of the present invention have been described and illustrated in detail, it will be evident to those skilled in the art that various modifications and changes may be made thereto without departing from the spirit and scope of the invention as set forth in the appended claims and equivalents thereof.

What is claimed is:

1. A method of operating a remote office having access to a plurality of documents comprising the steps of:
storing said plurality of documents on a storage medium;
providing a website accessible through an Internet;
when a user accesses said website, verifying said user is said remote office user;
providing a search engine for said remote office user to enter search terms to be found within said plurality of documents;
searching for said search terms within said plurality of documents;
displaying a list of found documents which contain said search terms;
providing said user with a selected one of said found documents.

2. A method of operating a remote office as in claim 1, wherein said providing step comprises displaying said document to said remote office user.

3. A method of operating a remote office as in claim 1, wherein said providing step comprises permitting said remote office user to print said selected document at said remote office user's location.

4. A method of operating a remote office as in claim 1, further comprising a step of scanning said plurality of documents prior to said storing step.

5. A method of operating a remote office as in claim 1, further comprising a step of converting an electronic format of at least one of said plurality of documents to a standard format of documents stored on said storage medium.

6. A virtual document filing system for an office comprising:
a storage medium;
a website accessible through an Internet, said website providing access to said storage medium for said office;
a security system, said security system being capable of verifying an identity of said office;
a search engine, said search engine enabling said office to search for terms within said representations of said documents stored on said storage medium.

7. A virtual document filing system as in claim 6, further comprising a scanner, said scanner being capable of scanning said documents to create said representations of said documents to be stored in said storage medium.

8. A virtual document filing system as in claim 6, further comprising an electronic document conversion tool, said electronic document conversion tool being capable of converting an electronic document into a standard format for a representation of a document to be stored on said storage medium prior to storage.
